(19) United States
(12) Patent Application Publication
(10) Pub. No.: US 2016/0036015 A1
(43) Pub. Date: Feb. 4, 2016

(54) RECHARGEABLE BATTERY HAVING EDGE BONDING PORTION

(71) Applicant: Samsung SDI Co., Ltd., Yongin-si (KR)

(72) Inventors: Seong-Su KIM, Yongin-si (KR); Jun-Sik KIM, Yongin-si (KR)

(21) Appl. No.: 14/734,936

(22) Filed: Jun. 9, 2015

(30) Foreign Application Priority Data
Aug. 4, 2014 (KR) 10-2014-0099834

(51) Int. Cl. H01M 2/04; H01M 2/02

(52) U.S. Cl. CPC H01M 2/0469; H01M 2/02; H01M 2/0207; H01M 2/0237; H01M 2220/30; H01M 2220/20

(57) ABSTRACT

An exemplary embodiment of the present invention provides a rechargeable battery including an electrode assembly for performing charging and discharging operations, and a pouch case including a receiving portion into which the electrode assembly is accommodated and an edge bonding portion formed outside of the receiving portion. The edge bonding portion is formed to be inclined at an angle of 5° to 70° with respect to a bottom surface of the pouch case.

### INCORPORATION BY REFERENCE TO ANY PRIORITY APPLICATIONS

This application claims priority to and the benefit of Korean Patent Application No. 10-2014-0099834 filed in the Korean Intellectual Property Office on Aug. 4, 2014, the entire contents of which are incorporated herein by reference.

### BACKGROUND OF THE INVENTION

1. Field of the Invention

The present invention relates to a rechargeable battery, and more particularly, to a rechargeable battery with an edge bonding portion.

2. Description of the Related Art

A rechargeable battery differs from a primary battery in that it can be repeatedly charged and discharged, while the latter is incapable of being recharged.

A low-capacity rechargeable battery is used in small portable electronic devices such as mobile phones, notebook computers, and camcorders, while a high-capacity rechargeable battery can be widely used as a power source for driving a motor of hybrid vehicles and the like.

Recently, high power rechargeable batteries using a non-aqueous electrolyte and having high energy density have been developed, and the high power rechargeable batteries are coupled in series or parallel, thereby forming a high power large capacity battery module.

In general, the rechargeable battery is equipped with an electrode assembly including a positive electrode, a negative electrode, and a separator interposed therebetween.

The electrode assembly is inserted in a case to perform charging and discharging operations, and is provided with terminals to and from which a current is supplied or drawn out.

The case may be formed of a metal plate or pouch, and a pouch case is formed as a laminate film in which an insulating layer is interposed between metal films.

Since a thin film type battery has a very small thickness, its sealing performance deteriorates when a width of its edge bonding portion is reduced according to its thickness.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a rechargeable battery for stably supporting a pouch case even without folding an edge bonding portion as well as maintaining sealing performance in a thin-walled type of battery.

An exemplary embodiment of the present invention provides a rechargeable battery including: an electrode assembly for performing charging and discharging operations; and a pouch case including a receiving portion into which the electrode assembly is accommodated and an edge bonding portion formed outside of the receiving portion. The edge bonding portion is formed to be inclined at an angle of 5° to 70° with respect to a bottom surface of the pouch case.

The rechargeable battery may include a frame including a first cover and a second cover facing and combined thereto that encase the pouch case, wherein a tilting protrusion is formed in the frame to contact and slantedly bend the edge bonding portion.

A width of the edge bonding portion may be formed larger than a thickness of the electrode assembly, and the width of the edge bonding portion may be 1.1 to 1.8 times the thickness of the electrode assembly.

Two tilting protrusions disposed to be spaced apart from each other may be formed in the second cover, and the receiving portion may be positioned between the tilting protrusions.

A mounting groove into which the receiving portion is inserted may be formed in the first cover, and the tilting protrusion may be inserted into the mounting groove such that it contacts an inner wall of the mounting groove.

A supporting protrusion for contacting and supporting an upper corner of the receiving portion may be formed in the mounting groove, and a bottom surface of the supporting protrusion may contact a top surface of the edge bonding portion to support the edge bonding portion.

An opening may be formed in the first cover to expose a top surface of the receiving portion.

According to the exemplary embodiment of the present invention, since the tilting protrusions are formed, the pouch case can be stably supported even without folding the edge bonding portion of the thin film type of battery.

In another aspect, the aforementioned needs are satisfied by an embodiment of a rechargeable battery comprising: an electrode assembly; a pouch case that includes a receive portion that receives the electrode assembly and an edge bonding portion that is positioned outside of the receive portion wherein the pouch case has a bottom surface; and a frame that receives the pouch case, wherein the frame defines an edge portion that has a slanted surface that receive the edge bonding portion.

In this embodiment, the frame includes a first and second cover that combined with each other to enclose the pouch case.

In this embodiment, one of the first or second covers includes an opening.

In this embodiment, the receive portion of the pouch case has a first thickness and the length of the edge bonding portion has a length that is greater than the first thickness of the pouch case.

In this embodiment, the width of the edge boding portion is 1.1 to 1.8 times the thickness of the electrode assembly.

In this embodiment, the pouch case has two edge bonding portions and the frame has two slanted surfaces that receive the two edge bonding portions.

In this embodiment, the frame defines a groove that receive the receive portion of the pouch case and wherein the groove defines a side wall that contacts the receive portion.

In this embodiment, the frame defines an opening contains the slanted surface.

In this embodiment, the opening is sized so that the frame contacts a top and a bottom surface of the edge bonding portion of the pouch case.

In this embodiment, the frame contacts the top and bottom surfaces of the edge bonding portion along the entire length of the edge bonding portion.

### BRIEF DESCRIPTION OF THE DRAWINGS

FIG. 1 is a perspective view of a rechargeable battery according to a first exemplary embodiment of the present invention.

FIG. 2 is a top plan view of the rechargeable battery according to the first exemplary embodiment of the present invention.

FIG. 3 is an exploded perspective view of a frame according to the first exemplary embodiment of the present invention.

FIG. 4 is a partial cross-sectional view of the rechargeable battery according to the first exemplary embodiment of the present invention.

FIG. 5 is a partial cross-sectional view of a rechargeable battery according to a second exemplary embodiment of the present invention.

FIG. 6 is a partial cross-sectional view of a rechargeable battery according to a third exemplary embodiment of the present invention.

FIG. 7 is an exploded perspective view of a frame according to a fourth exemplary embodiment of the present invention.

FIG. 8 is a partial cross-sectional view of a rechargeable battery according to the fourth exemplary embodiment of the present invention.

### DETAILED DESCRIPTION OF THE PREFERRED EMBODIMENT

The present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

In addition, like reference numerals designate like elements throughout the specification and the drawings.

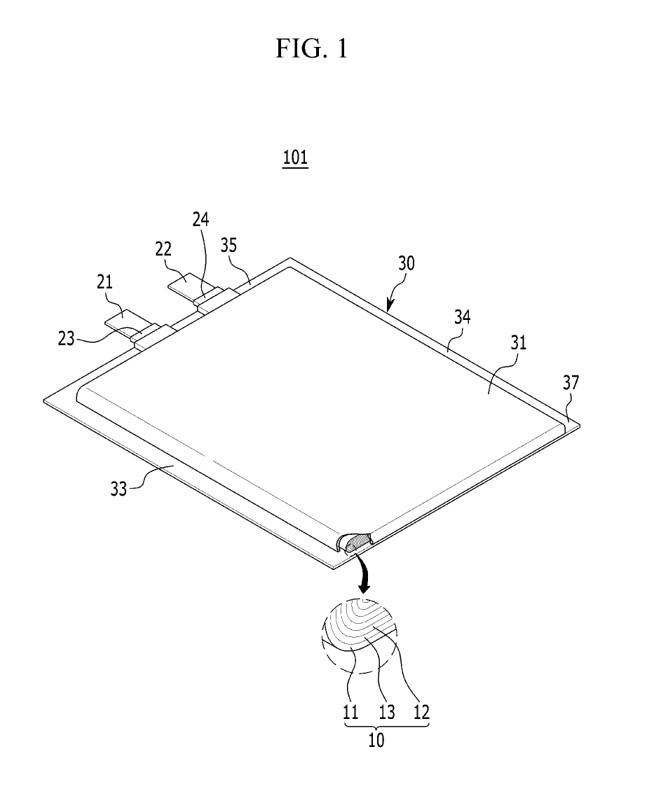

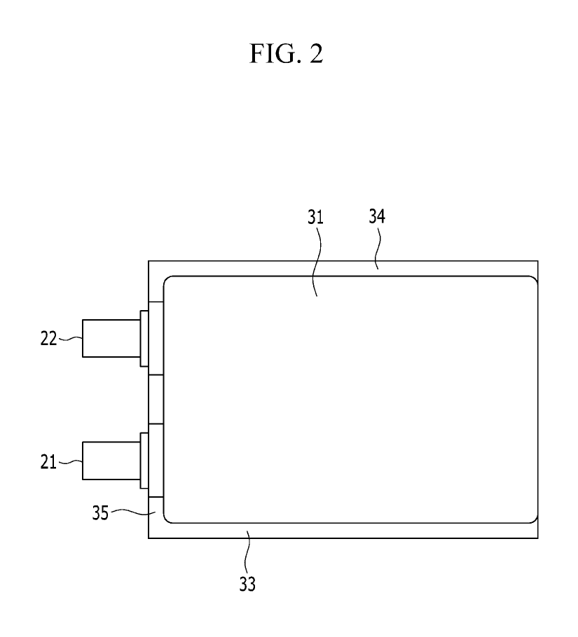

FIG. 1 is a perspective view of a rechargeable battery according to a first exemplary embodiment of the present invention, and FIG. 2 is a top plan view of the rechargeable battery according to the first exemplary embodiment of the present invention.

Referring to FIGS. 1-3, a rechargeable battery 101 according to the present exemplary embodiment includes: an electrode assembly 10 for performing charging and discharging operations; a pouch case 30 in which the electrode assembly 10 is placed, and a frame 40 for encasing the pouch case 30.

The electrode assembly 10 includes a positive electrode 11, a negative electrode 12, and a separator 13 interposed between the positive and negative electrodes 11 and 12.

The positive electrode 11 includes a positive electrode current collector that is formed of a strip-shaped thin metallic plate, and a positive electrode active material layer that is coated on one surface or opposite surfaces of the positive electrode current collector.

The positive electrode current collector may be formed of a metallic material having excellent conductivity, for example, a thin aluminum plate.

The positive electrode active material layer may be formed of a material in which a lithium-based oxide is mixed with a binder, a conductive material, etc.

The negative electrode 12 includes a negative electrode current collector that is formed of a strip-shaped thin metallic plate, and a negative active material layer that is coated on one surface or opposite surfaces of the negative electrode current collector.

The negative electrode current collector may be formed of a metallic material having excellent conductivity, for example, a thin copper plate.

The negative active material layer may be formed of a material in which a negative active material such as a carbon material and the like is mixed with a binder conductive material and the like.

The separator 13 is formed of a porous material, and may be formed of polyolefin, polyethylene, polypropylene, etc.

The positive electrode 11 includes a positive electrode coated region where a positive electrode active material layer is coated, and a positive electrode uncoated region where a positive electrode active material layer is not coated.

The negative electrode 12 includes a negative electrode coated region where a negative active material layer is coated, and a negative electrode uncoated region where a negative active material layer is not coated.

The positive electrode uncoated region is disposed at one lateral end of the electrode assembly 10 in a length direction thereof, and the negative electrode uncoated region is disposed at the other lateral end of the electrode assembly 10 in the length direction thereof.

A positive electrode tab 21 is bonded to the positive electrode uncoated region, and a negative electrode tab 22 is bonded to the negative electrode uncoated region.

The positive and negative electrode tabs 21 and 22 protrude outwardly from the pouch case 30, and protective tapes 23 and 24 are wound around the positive and negative electrode tabs 21 and 22 to insulate the pouch case 30 therefrom.

The pouch case 30 includes upper and lower plates, and the upper and lower plates are thermo-bonded to form a receiving portion 31 and edge bonding portions 33 and 34.

The receiving portion 31 convexly protrudes to accommodate the electrode assembly 10 therein, and is disposed at a center of the pouch case 30.

The receiving portion 31 has a quadrangular cross-section.

An upper bonding portion 35 is formed in a part of the pouch case 30 where the positive and negative electrode tabs 21 and 22 protrude.

The edge bonding portions 33 and 34 are formed at opposite lateral ends of the receiving portion 31 such that they are elongated along a length direction of the receiving portion 31.

The edge bonding portions 33 and 34 are formed to be elongated from one end portion of the receiving portion 31 to the upper bonding portion 35, and are disposed such that the receiving portion 31 is enclosed by the edge bonding portions 33 and 34 and the upper bonding portion 35.

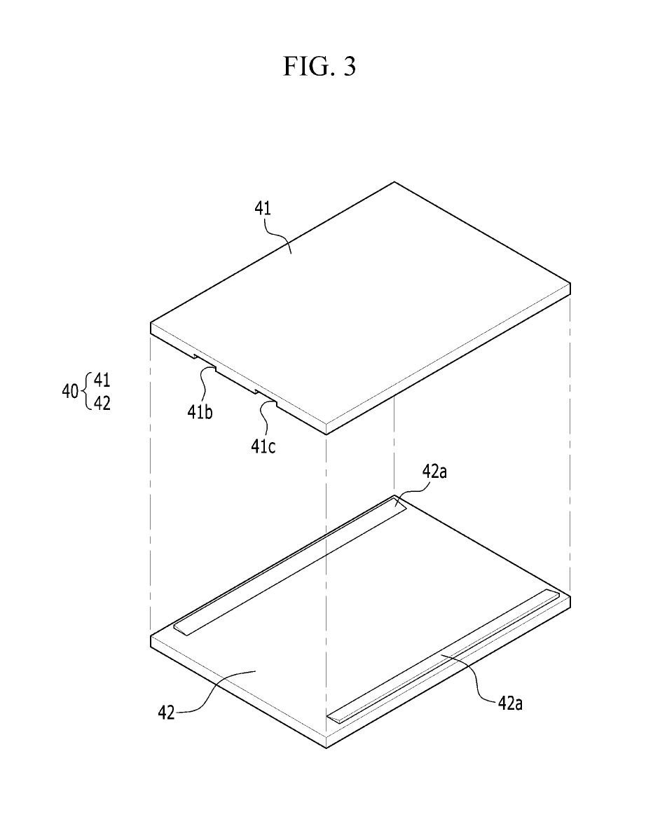

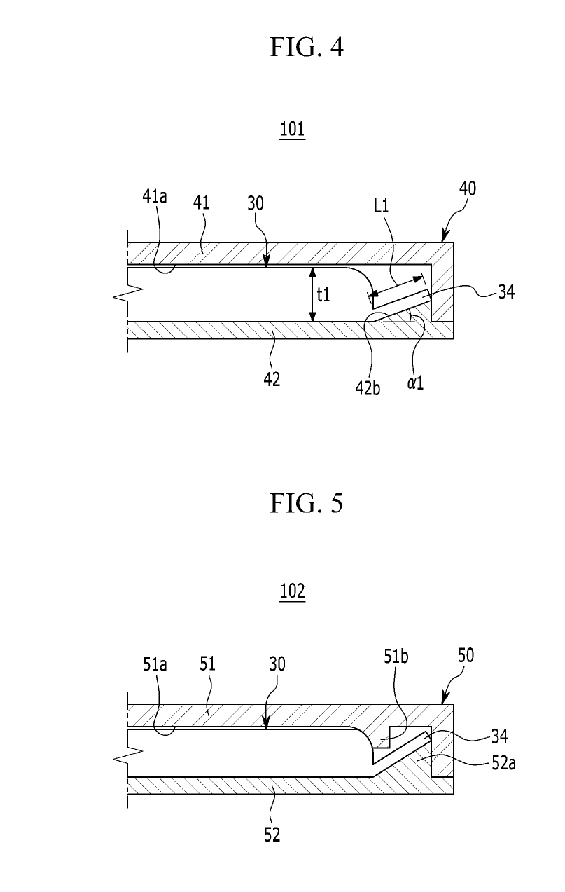

FIG. 3 is an exploded perspective view of the frame according to the first exemplary embodiment of the present invention, and FIG. 4 is a partial cross-sectional view of the rechargeable battery according to the first exemplary embodiment of the present invention.

Referring to FIGS. 3 and 4, a width L1 of the edge bonding portions 33 and 34 is formed larger than a thickness t1 of the electrode assembly 10, and the width L1 of the edge bonding portions 33 and 34 may be 1.1 to 1.8 times the thickness t1 of the electrode assembly 10.

Since the aforementioned electrode assembly 10 consists of the electrode assembly 10 for a thin film type of battery, the thickness t1 of electrode assembly 10 may be 1.0 mm to 2.6 mm.

The frame 40 includes a first cover 41 and a second cover 42 facing and combined thereto that encase the pouch case 30.

The first cover 41 is disposed above the pouch case 30, and the second cover 42 is disposed below the pouch case 30.

A mounting groove 41a into which the receiving portion 31 is inserted is formed in the first cover 41.

The mounting groove 41a is positioned at a center of the first cover 41, and the aforementioned receiving portion 31 is inserted into the mounting groove 41a.

A terminal groove 41b into which the positive electrode tab 21 is inserted and a terminal groove 41c into which the negative electrode tab 22 is inserted are formed in the first cover 41.

Tilting protrusions 42a are formed in the second cover 42 to contact and slantedly bend the edge bonding portions 33 and 34, two tilting protrusions 42a are disposed to be separated from each other in the second cover 42, and the tilting protrusions 42a are formed to be elongated in a length direction of the edge bonding portions 33 and 34.

In addition, the receiving portion 31 is positioned between the tilting protrusions 42a.

Further, the tilting protrusions 42a are inserted into the mounting groove 41a to contact an inner wall of the mounting groove 41a.

Top surfaces of the tilting protrusion 42a contacting bottom surfaces of the edge bonding portions 33 and 34 is formed to be inclined at a tilt angle α1 of 5° to 70° with respect to a top surface of the second cover 42.

Accordingly, the edge bonding portions 33 and 34 positioned above the tilting protrusion 42a are also formed to be inclined at an angle of 5° to 70° with respect to a bottom surface of the pouch case.

When the tilting protrusions 42a are formed as shown in the present exemplary embodiment, the edge bonding portions 33 and 34 are supported by the tilting protrusions 42a, thereby allowing the receiving portion 31 to be easily positioned between the tilting protrusions 42a.

In addition, the pouch case 30 is prevented from being moved inside the frame 40 due to external impact or vibration.

FIG. 5 is a partial cross-sectional view of a rechargeable battery according to a second exemplary embodiment of the present invention.

Referring to FIG. 5, since the rechargeable battery according to the present exemplary embodiment has the same structure as the rechargeable battery according to the aforementioned first exemplary embodiment, except for a frame structure, a repeated description of the same structure will be omitted.

The rechargeable battery 102 according to the present exemplary embodiment includes an electrode assembly 10 for performing charging and discharging operations, a pouch case 30 in which the electrode assembly 10 is accommodated, and a frame 50 for encasing the pouch case 30.

The frame 50 includes a first cover 51 and a second cover 52 facing and combined thereto that encase the pouch case 30.

The first cover 51 is disposed above the pouch case 30, and the second cover 52 is disposed below the pouch case 30.

A mounting groove 51a into which the receiving portion 31 is inserted is formed in the first cover 51.

The mounting groove 51a is positioned at a center of the first cover 51, and the aforementioned receiving portion 31 is inserted into the mounting groove 51a.

A supporting protrusion 51b is formed in the mounting groove 51a to contact and support an upper corner of the receiving portion 31.

Two supporting protrusions 51b are formed in the mounting groove 51a, and the supporting protrusions 51b are disposed to be separated from each other.

The supporting protrusions 51b contact lateral end corners of the receiving portion 31, and are elongated along lateral ends of the receiving portion 31.

Once the supporting protrusions 51b are formed, the pouch case can be more stably supported.

Tilting protrusion 52a are formed in the second cover 52 to contact and slantedly bend the edge bonding portion 34, two tilting protrusions 52a are separately disposed in the second cover 52, and the tilting protrusions 52a are formed to be elongated in a length direction of the edge bonding portion 34.

In addition, the receiving portion 31 is positioned between the tilting protrusions 52a.

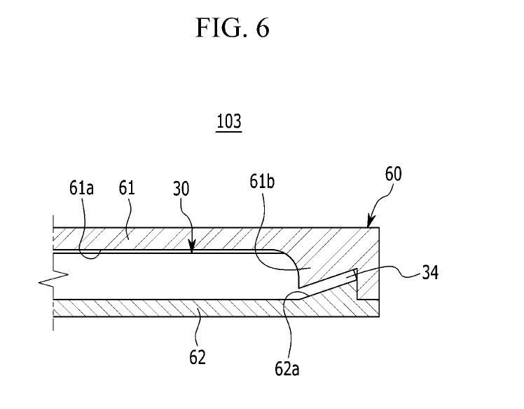

FIG. 6 is a partial cross-sectional view of a rechargeable battery according to a third exemplary embodiment of the present invention.

Referring to FIG. 6, since the rechargeable battery according to the present exemplary embodiment has the same structure as the rechargeable battery according to the aforementioned first exemplary embodiment, except for a frame structure, a repeated description of the same structure will be omitted.

The rechargeable battery 103 according to the present exemplary embodiment includes an electrode assembly 10 for performing charging and discharging operations, a pouch case 30 in which the electrode assembly 10 is accommodated, and a frame 60 for encasing the pouch case 30.

The frame 60 includes a first cover 61 and a second cover 62 facing and combined thereto that encase the pouch case 30.

The first cover 61 is disposed above the pouch case 30, and the second cover 62 is disposed below the pouch case 30.

A mounting groove 61a into which the receiving portion 31 is inserted is formed in the first cover 61.

The mounting groove 61a is positioned at a center of the first cover 61, and the aforementioned receiving portion 31 is inserted into the mounting groove 61a.

A supporting protrusion 61b is formed in the mounting groove 61a to contact and support an upper corner of the receiving portion 31.

Two supporting protrusions 61b are formed in the mounting groove 61a, and the supporting protrusions 61b are disposed to be separated from each other.

The supporting protrusions 61b contact lateral end corners of the receiving portion 31, and are elongated along lateral ends of the receiving portion 31.

Meanwhile, a bottom surface of the supporting protrusion 61b is disposed to contact a top surface of the edge bonding portion 34 such that it support the edge bonding portion 34.

Tilting protrusion 62a are formed in the second cover 62 to contact and slantedly bend the edge bonding portion 34, two tilting protrusions 62a are separately disposed in the second cover 62, and the tilting protrusions 62a are formed to be elongated in a length direction of the edge bonding portion 34.

In addition, the receiving portion 31 is positioned between the tilting protrusions 62a.

Accordingly, the edge bonding portion 34 is inserted between the supporting protrusion 61b and the tilting protrusion 62a, and is stably supported therebetween.

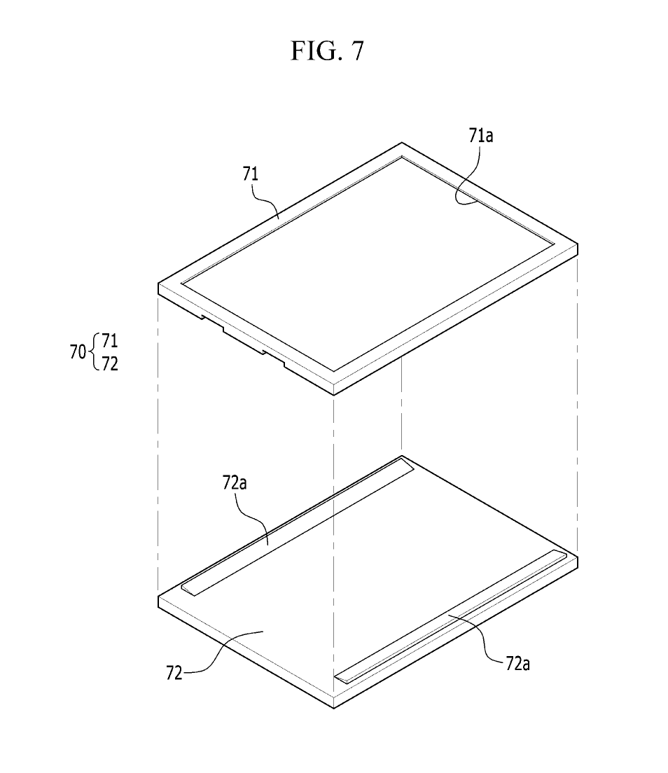

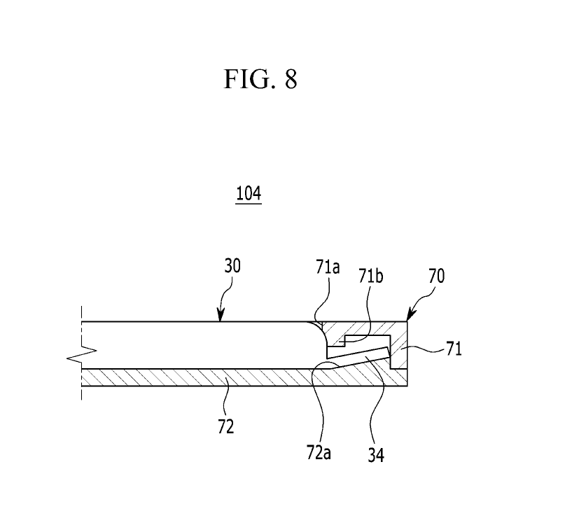

FIG. 7 is an exploded perspective view of a frame according to a fourth exemplary embodiment of the present invention, and FIG. 8 is a partial cross-sectional view of a rechargeable battery according to the fourth exemplary embodiment of the present invention.

Referring to FIGS. 7 and 8, since the rechargeable battery according to the present exemplary embodiment has the same structure as the rechargeable battery according to the aforementioned first exemplary embodiment, except for a frame structure, a repeated description of the same structure will be omitted.

The rechargeable battery 104 according to the present exemplary embodiment includes an electrode assembly 10 for performing charging and discharging operations, a pouch case 30 in which the electrode assembly 10 is accommodated, and a frame 70 for encasing the pouch case 30.

The frame 70 includes a first cover 71 and a second cover 72 facing and fitted into the first cover that encase the pouch case 30.

The first cover 71 is disposed above the pouch case 30, and the second cover 72 is disposed below the pouch case 30.

An opening is formed in the first cover 71 to expose a top surface of the receiving portion.

In addition, a supporting protrusion 71b is formed below the opening to contact and support an upper corner of the receiving portion 31.

Two supporting protrusions 71b are formed in a mounting groove 71a, and the supporting protrusions 71b are disposed to be separated from each other.

The supporting protrusions 71b contact lateral end corners of the receiving portion, and are elongated along lateral ends of the receiving portion 31.

Tilting protrusions 72a are formed in the second cover 72 to contact and slantedly bend the edge bonding portion 34, two tilting protrusions 72a are separately disposed in the second cover 72, and the tilting protrusions 72a are formed to be elongated in a length direction of the edge bonding portion 34.

In addition, the receiving portion 31 is positioned between the tilting protrusions 72a.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
an electrode assembly for performing charging and discharging operations; and
a pouch case including a receiving portion into which the electrode assembly is accommodated and an edge bonding portion formed outside of the receiving portion, wherein the edge bonding portion is formed to be inclined at an angle of 5° to 70° with respect to a bottom surface of the pouch case.

2. The rechargeable battery of claim 1, including a frame including a first cover and a second cover facing and combined thereto that encase the pouch case, wherein a tilting protrusion is formed in the frame to contact and slantedly bend the edge bonding portion.

3. The rechargeable battery of claim 2, wherein a width of the edge bonding portion is formed larger than a thickness of the electrode assembly.

4. The rechargeable battery of claim 3, wherein the width of the edge bonding portion is 1.1 to 1.8 times the thickness of the electrode assembly.

5. The rechargeable battery of claim 2, wherein two tilting protrusions disposed to be spaced apart from each other are formed in the second cover, and the receiving portion is positioned between the tilting protrusions.

6. The rechargeable battery of claim 2, wherein a mounting groove into which the receiving portion is inserted is formed in the first cover.

7. The rechargeable battery of claim 6, wherein the tilting protrusion is inserted into the mounting groove such that it contacts an inner wall of the mounting groove.

8. The rechargeable battery of claim 6, wherein a supporting protrusion is formed in the mounting groove to contact and support an upper corner of the receiving portion.

9. The rechargeable battery of claim 8, wherein a bottom surface of the supporting protrusion contacts a top surface of the edge bonding portion to support the edge bonding portion.

10. The rechargeable battery of claim 1, wherein an opening is formed in the first cover to expose a top surface of the receiving portion.

11. A rechargeable battery comprising: an electrode assembly;
a pouch case that includes a receive portion that receives the electrode assembly and an edge bonding portion that is positioned outside of the receive portion wherein the pouch case has a bottom surface;
a frame that receives the pouch case, wherein the frame defines an edge portion that has a slanted surface that receive the edge bonding portion.

12. The battery of claim 11, wherein the frame includes a first and second cover that combined with each other to enclose the pouch case.

13. The battery of claim 12, wherein one of the first or second covers includes an opening.

14. The battery of claim 11, wherein the receive portion of the pouch case has a first thickness and the length of the edge bonding portion has a length that is greater than the first thickness of the pouch case.

15. The battery of claim 14, wherein the width of the edge boding portion is 1.1 to 1.8 times the thickness of the electrode assembly.

16. The battery of claim 11, wherein the pouch case has two edge bonding portions and the frame has two slanted surfaces that receive the two edge bonding portions.

17. The battery of claim 11, wherein the frame defines a groove that receive the receive portion of the pouch case and wherein the groove defines a side wall that contacts the receive portion.

18. The battery of claim 17, wherein the frame defines an opening contains the slanted surface.

19. The battery of claim 18, wherein the opening is sized so that the frame contacts a top and a bottom surface of the edge bonding portion of the pouch case.

20. The battery of claim 19, wherein the frame contacts the top and bottom surfaces of the edge bonding portion along the entire length of the edge bonding portion.
